(19) United States
(12) Patent Application Publication
(10) Pub. No.: US 2018/0341851 A1
(43) Pub. Date: Nov. 29, 2018

(54) TUNING OF A MACHINE LEARNING SYSTEM

(71) Applicant: International Business Machines Corporation, Armonk, NY (US)

(72) Inventors: I-Hsin CHUNG, Chappaqua, NY (US); John A. GUNNELS, YORKTOWN HEIGHTS, NY (US); Changhoan KIM, Ossining, NY (US); Michael P. PERRONE, YORKTOWN HEIGHTS, NY (US); Bhuvana RAMABHADRAN, Mount Kisco, NY (US)

(21) Appl. No.: 15/603,597

(22) Filed: May 24, 2017

(51) Int. Cl. G06N 3/08; G06N 3/04

(52) U.S. Cl. CPC G06N 3/08; G06N 3/04

(57) ABSTRACT

Optimizing the performance of a machine learning system includes: defining an n-dimensional approximate computing configuration space, the n-dimensional approximate computing configuration space defining tuning parameters for tuning the machine learning system; setting a performance objective for the machine learning system that identifies one or more machine learning system performance criteria; collecting and monitoring performance data; comparing the performance data to the machine learning system performance objective; and dynamically updating the n-dimensional approximate computing configuration space by adjusting the at least one tuning parameter, in response to the comparison.

### BACKGROUND

The present invention generally relates to machine learning and more specifically relates to tuning a machine learning system using approximate computing.

A neural network is an artificial neural network (ANN) modeled after the functioning of the human brain, with weighted connections among its nodes, or “neurons.” A deep neural network (DNN) is an artificial neural network with multiple “hidden” layers between its input and output layers. The hidden layers of a DNN allow it to model complex nonlinear relationships featuring higher abstract representations of data, with each hidden layer determining a non-linear transformation of a prior layer.

The neural network model is typically trained through numerous iterations over vast amounts of data. As a result, training a DNN can be very time-consuming and computationally expensive. For example, in training DNNs to correctly identify faces, thousands of photographs of faces (of people, animals, famous faces, and so on) are input into the system. This is the training data. The DNN processes each photograph using weights from the hidden layers, comparing the training output against the desired output. A goal is that the training output matches the desired output, e.g., for the neural network to correctly identify each photo (facial recognition).

When the error rate is sufficiently small (e.g., the desired level of matching occurs), the neural network can be said to have reached “convergence.” In some situations, convergence means that the training error is zero, while in other situations, convergence can be said to have been reached when the training error is within an acceptable threshold. The system begins with a high error rate, as high as 100% in some cases. Errors (e.g., incorrect identifications) get propagated back for further processing, often through multiple iterations, with the system continually updating the weights. The number of iterations increases with the sample size, with neural networks today running in excess of 100,000 iterations. Even with the processing power of today's supercomputers, some DNNs never achieve convergence.

The complexities of training machine learning networks can take months, even when using dozens of compute nodes simultaneously.

### SUMMARY

One embodiment of the present invention is a computer-implemented method using approximate computing on a machine learning model. An exemplary embodiment includes: defining, by a computer, within a machine learning system, an n-dimensional approximate computing configuration space, which includes at least one tuning parameter; setting, by the computer, a performance objective for the machine learning system that identifies one or more machine learning system performance criteria; collecting and monitoring performance data of the machine learning system performance; comparing the performance data to the machine learning system performance objective; and dynamically updating the n-dimensional approximate computing configuration space by adjusting the at least one tuning parameter.

Other embodiments of the present invention include a system and computer program product.

### BRIEF DESCRIPTION OF THE DRAWINGS

In the accompanying figures, like reference numerals refer to identical or functionally similar elements throughout the separate views. The accompanying figures, together with the detailed description below are incorporated in and form part of the specification and serve to further illustrate various embodiments and to explain various principles and advantages all in accordance with the present invention, in which:

FIG. 1 is a block diagram of exemplary components of a system using approximate computing, according to an embodiment of the present invention;

FIG. 2 is a flow diagram of an exemplary process, according to an embodiment of the present invention;

FIG. 3 is an operational flow diagram of an exemplary approximate computing tuning process, according to an embodiment of the present invention;

FIG. 4 is a block diagram of an exemplary performance profiling system with approximate computing, according to an embodiment of the present invention;

FIG. 5 shows an exemplary user interface featuring a dashboard, according to an embodiment of the present invention;

FIG. 6 is a flow diagram of an exemplary approximate computing tuning process, according to an embodiment of the present invention; and

FIG. 7 illustrates a block diagram of an exemplary system for tuning machine learning systems, according to an embodiment of the present invention.

### DETAILED DESCRIPTION

### Non-Limiting Definitions

The term “approximate computing” means introducing computations that are known to sacrifice accuracy in non-critical data when an approximate result is good enough to serve a purpose.

The term “artificial neural network” or “ANN” is a learning system modeled after the human brain, with a large number of processors operating in parallel.

The term “burst buffer” refers to a layer of storage that absorbs bulk data produced by an application at a higher rate than a parallel file system.

The term “deep neural network” or “DNN” refers to an artificial neural network having multiple hidden layers of neurons between the input and output layers.

The term “FLOPs” refers to floating point operations per second.

The term “hyperparameters” refers to parameters that define properties of the training model, but cannot be learned from the process of training the model. Hyperparameters are usually set before the actual training process begins and describe properties such as: the depth of a tree, the rate of learning, the number of hidden layers, or the number of clusters. They are also known as “meta parameters.”

The term “model parameters” refers to the parameters in a machine learning model. Model parameters are learned from training data.

The term “meta parameters” is another term for “hyperparameters.”

The term “patch” means a piece of software code inserted into a program to report on a condition or to correct a condition.

The term “pipelining” refers to a serially connected data processing elements, such that the output of one element is the input of the next element.

The term “probe” means a device (software or hardware) inserted at a key position in a system to collect data about the system while it runs.

The term “sparsification” means to approximate a given graph using fewer edges or vertices.

The term “training parameters” is another term for model parameters.

### Approximate Computing Applied to Machine Learning

By way of overview and example (only), some embodiments of the present invention use approximate computing to improve performance of a machine learning system. In some embodiments, a technological improvement in the field of machine learning is achieved by applying approximate computing to dynamically tune a machine learning model such as, for example, a DNN model. In some embodiments, an automated mechanism dynamically adjusts the configuration of hardware and/or software, to achieve desired performance objectives within a machine learning framework. A few examples of such performance objectives include (without limitation): learning, resource utilization, power utilization, accuracy, and latency.

Some embodiments use a variety of approximate computing techniques during a training phase. For example, the training process may be dynamically fine-tuned to reduce the computation overhead and communication latencies, thus expediting the training process. Other performance improvements can be achieved as well. In some embodiments, the same (or similar) approximate computing techniques can dynamically fine-tune a system during production. For example, there can be a trade-off between the time to calculate a machine learning model's response and the accuracy of the response. In some embodiments, dynamic monitoring/tuning allows an operator to prioritize among performance goals/objectives, such as prioritizing accuracy over speed. Once a performance goal/objective is established, the use of approximate computing can be introduced on a case by case basis, e.g., when speed is desirable over accuracy (e.g., changing response times for autonomous vehicles depending on traffic situations, or certain market trading scenarios). It should be noted that different use conditions, such as production vs. training, can have differing optimization requirements. Consequently, the tuning can vary, depending on the requirements.

An imbalance can occur within a machine learning system. For example, at some times, computation activity can be relatively more intensive than communication activity, while at other times the communication activity can be relatively more intensive than computation activity. Practitioners can be tasked with finding a balance between performance objectives such as computation and communication. In some embodiments of the present invention, in order to facilitate such balancing, one or more performance parameters, such as: communication and computation times, bandwidth utilization, cache misses, stalls, FLOPs, accuracy, load imbalance, among others, are monitored; and a tuning process dynamically adjusts the performance parameters to improve balance.

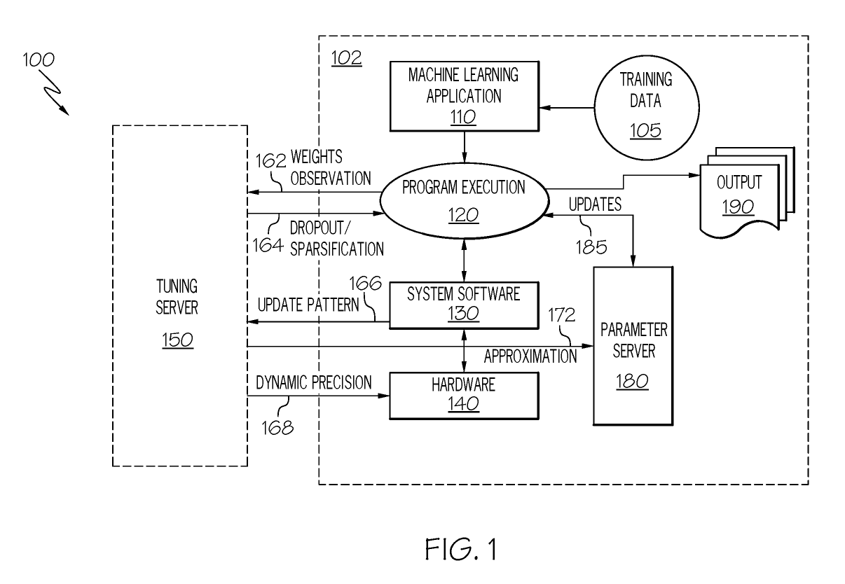

Some embodiments using approximate computing in accordance with the present invention have two phases: monitoring and tuning. In some embodiments, the monitoring and tuning phases may (at least partially) overlap. An example of such overlapping phases will be discussed with reference to FIG. 1.

During a monitoring phase, (in some embodiments) performance can be monitored and performance data gathered, in a background process. In some embodiments, performance data can be collected from probes that provide data on system performance with respect to a specified performance goal e.g., communication and computation times. In a training system, the data can be gathered during multiple iterations of a training run. Overall system performance is monitored, as well as the progress of the training.

During a tuning phase, adjustments can be made in the area of approximate computing by dynamically adjusting the tuning parameters, when the opportunity arises e.g., during a training or production run. For purposes of this example only, meta parameters that are initially set before the process starts are referred to as “tuning parameters.” Such tuning parameters are not the same as the training (or model) parameters. For example, consider that bit resolution can be a tuning parameter. The bit resolution of computation could be varied (or tuned) to allow more or less parallelism and thereby vary computation time on a given compute node, with a concomitant impact on computation accuracy. Similarly, the communication bit resolution could be varied to increase or decrease the communication time, with a concomitant impact on communication accuracy. Some examples of training parameters are: maximum model size, maximum number of passes over the training data (iterations), and shuffle type.

Also within an approximate computing framework, other tuning parameters can be adjusted, such as: data compression, update frequency, and mini-batch size, to name a few. For example, adjustments can include: using dropout sparsification to send a quasi-random subset of weights, rolling updates that transmit only a pre-specified subset of weights in a round-robin fashion, variable bit truncations of the weights to be combined, and a combination of the foregoing. Additionally, the following approximate computing techniques can also be used: requesting a precision with which data is represented that is different from that configured in hardware; varying the precision over a single update; varying what is communicated e.g., the portion of the update that is communicated; skipping one or more updates; changing the update step size; changing the data that is used; changing the mini-batch size; and the choice of computation. Many other examples can be contemplated, within the spirit and scope of the invention.

By taking advantage of system architecture and/or system software features (e.g., observation of sequence of weight updates and precision requirement, etc.), together with supports from system hardware/system software, operators can reduce the computation and communication times and thereby optimize the training/production process.

FIG. 1 is a block diagram of exemplary components of a system using approximate computing, according to some embodiments of the present invention. As depicted, the system can be a machine learning system 100, that includes a tuning server 150. In some embodiments, the tuning server 150 is integrated with one or more components of an approximate computing framework 102. The tuning server 150 monitors and dynamically tunes the configuration of the machine learning system 100 to achieve a specified performance goal/objective (for example, time, temperature, energy savings).

The tuning server 150 can provide a dual-phase service. In one phase, the tuning server 150 can work in a background process, monitoring the performance of the machine learning system 100, while the machine learning system 100 is running in a parallel foreground process. In another phase, the tuning server 150 dynamically adjust the machine learning system 100 configuration based on what it has observed from the monitoring phase.

In some embodiments, the machine learning system 100 runs an application 110 that receives as input training data 105 and produces (via training program execution unit 120) output 190. For example, in the field of facial recognition, the training data 105 can be thousands of images of faces, and the output 190 can be the names matching the faces. It will be understood that the application 110 depicted here is representative of exemplary processes for machine learning and in actuality encompass several applications, functions, algorithms, and the like, residing on a single machine or distributed across multiple machines.

The training program execution unit 120 uses system software 130 and hardware 140 configured to support a machine learning process. The parameter server 180 is part of a machine learning system 100. In a machine learning system incorporating a DNN, for example, there are neurons and connections between the neurons (not depicted). For each connection, each edge, there is a weight associated with the edge—these are some of the values that are stored in the parameter server 180. The weights are derived from the model that is being trained. For each iteration, links for the weights and values for the weights themselves are re-estimated and updated. Updates 185 are fed back into the program execution 120. Training parameters such as: maximum model size, maximum number of passes over the training data (iterations), shuffle type, regularization type, and regularization amount can be specified and stored in the parameter server 180.

Whereas the goal of a machine learning system 100 is training accuracy (convergence), the goal of the tuning server 150 can be modified e.g., defined by the operator, and can frequently change. The goal of the tuning server 150 can range from a general performance goal, such as “find an optimal (or near optimal) hardware/software configuration to more efficiently and expediently reach convergence,” to a more specific performance goal, such as “reduce cost by decreasing processors.”

The actions taken by the tuning server 150 can be very different, depending on the desired performance objective. The desired performance objective is achieved by observing and monitoring the performance of the machine learning system 100 and dynamically fine-tuning the machine learning system 100 throughout many iterations, which can include training and/or production runs. During the monitoring phase, a few examples of performance parameters of interest include (without limitation): learning time, resource utilization, power utilization, accuracy, and latency. The respective training parameter weights 162 are gathered, along with the performance data from the program execution unit 120. During the tuning phase, adjustments can be made to the tuning parameters, such as dropout/sparsification 164, pattern updates 166, and dynamic precision 168. Additionally, the training parameters themselves can be adjusted within the context of approximate computing, with the approximations 172 provided to the parameter server 180.

In some embodiments, the tuning server 150 includes a kernel (not depicted), which can include mathematical optimization methods/algorithms that apply to a high-dimensional search space. The tuning server 150 uses several methods/algorithms to find a configuration in a high-dimensional search space. For example, linear programming algorithms, iterative methods (e.g., Newton's method, conjugate gradient), and heuristic algorithms (e.g., genetic algorithms) can be used in the implementation. A heuristic search can allow the high-dimensional (tuning) parameter space to be explored randomly.

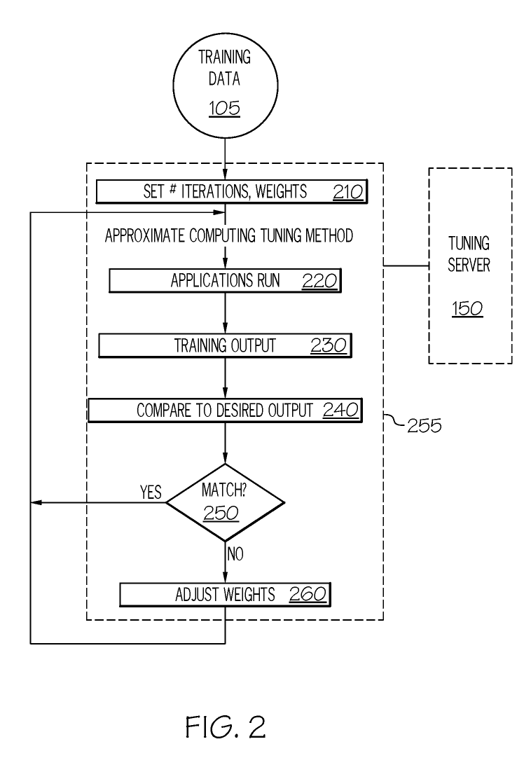

FIG. 2 depicts a flow diagram of an exemplary process of applying approximate computing to the operation of a machine learning system 100, according to an embodiment of the present invention. As depicted. the training data 105 that will be input into the machine learning system 100 is gathered. The (gathered) training data 105 is provided and in step 210, the number of iterations, along with the weights, are set. An iteration of the process is run in step 220. During the training phase, the approximate computing tuning method 255 is running as a background process.

After an iteration, the training output 190 is collected in step 230 and in step 240 the training output 190 is compared to the desired output. If the training output 190 matches the desired output, then the process returns to step 220 to continue running iterations. However, if the training output 190 does not match the desired output as determined in step 250, then in step 260 the training program execution unit 120 determines weight adjustments using algorithms stored in the parameter server 180 and the process loops back until all of the iterations (perhaps thousands) are run.

According to some embodiments of the present invention (an example of which is discussed below), the approximate computing tuning method 255 implementation of a tuning server 150 monitors and dynamically adjusts tuning parameters to improve system performance A few (non-limiting) examples of performance criteria include: convergence rate, gradient update momentum, time to compute a mini-batch, time to communicate an update, and others.

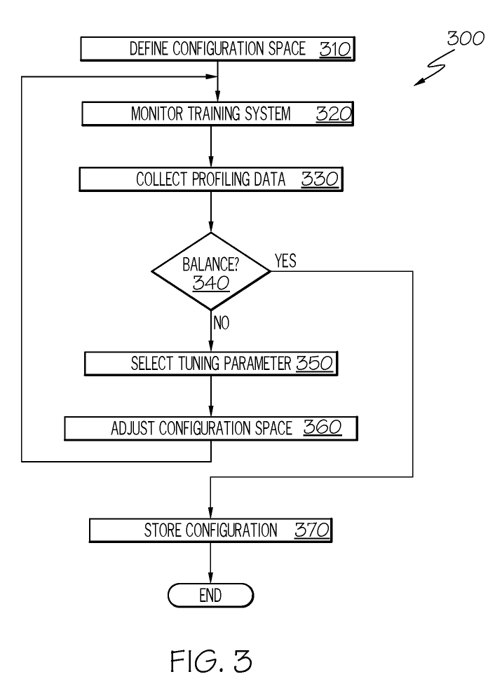

FIG. 3 is an operational flow diagram 300 of an exemplary approximate computing tuning process 255, according to an embodiment of the present invention. In this example, the approximate computing tuning method 255 is performed by the tuning server 150 and is a two-phase process, including a monitoring phase and a tuning phase.

In step 310, an n-dimensional approximate computing configuration space (“R”), is defined. The n-dimensional approximate computing configuration space can represent one or more specific tuning parameters, such as compression, single vs. double precision, frequency of updates, and size of batches, to name a few. A configuration point (“C”) represents a point within R, such as: no compression, single precision, update every iteration, batch size=16, and others. In some embodiments, C represents the current state of the system configuration, including both hardware and software performance criteria.

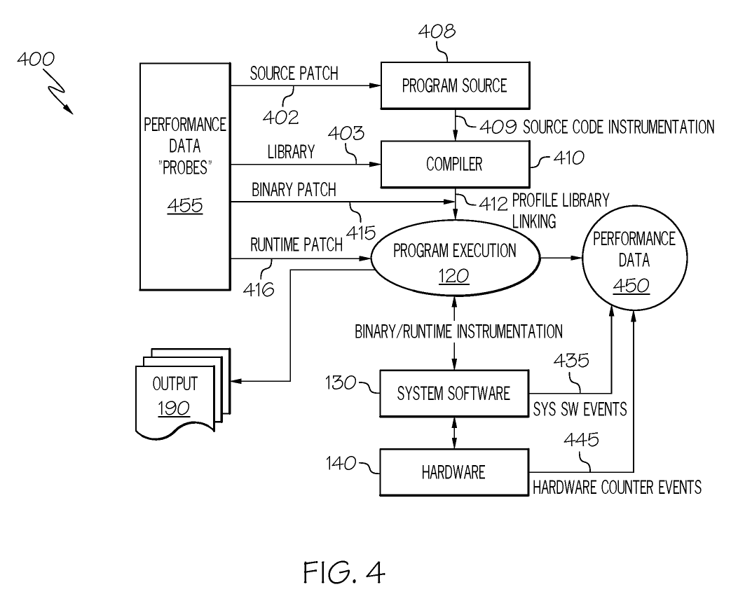

After defining the configuration space R, and setting C, in step 320 the machine learning system 100 can be monitored in a background process. During the monitoring phase, the instrumented training code can be profiled for communication and computation characteristics. This can be done by using performance analyzing tools relying on known data analytics functions such as probes, and/or software patches (an example of which is discussed with reference to FIG. 4), and changes to run-time control parameters. In some embodiments, data analytic probes are inserted into the program code, providing workload performance profiling statistics/data on the running system. The insertion of patches can be done at compile time (i.e. before the training starts) or during the training/production use of the system 100.

In step 330, workload profiling data is collected. A measurement profile (“M”), based on the collected data is fed into learning, search, and/or tuning algorithms executed by the tuning server 150. The learning, search, and/or tuning algorithms can take any of the various forms known to those skilled in the art, including but not limited to, look-up tables, neural networks, decision trees, and the like. M includes the actual measurements (e.g. execution time, energy consumed, communication bandwidth utilized, training result accuracy, etc.).

In some embodiments, the performance objective may be changed in response to the results of the monitoring phase. From the observation of the system performance, a particular area of concern can emerge; for example, a communication lag may be noted. Assuming that communication speed was not the initial performance objective, but now that the communication lag was noted, the performance objective can be changed to focus further attention on the communication speed. In step 340, the tuning server 150 checks the performance criteria to determine if the system is in balance, with respect to its performance objective. In one example, the tuning server 150 iteratively computes the ratio of the communication and compute times to determine if the system is in balance, i.e. to determine if the ratio of communication/computation lies within a desired threshold. If the system is not in balance, at least one tuning parameter is selected at step 350 to address the particular area of concern noted during the observation.

The tuning parameter in a general sense of this example can be considered the “knob” that is “turned” when tuning a machine learning model. Although there may be some overlap, tuning parameters generally differ from standard model parameters in that tuning parameters are used to control the flow of the training process but do not generally learn from the model data, as do training parameters. Some examples of tuning parameters are: mini-batch size, number of hidden layers in a DNN, number of nodes for parallelization, the learning step size, the size of the model, to name a few.

Algorithmically, an objective function F can be selected to extremize (e g minimize the execution time, maximize the CPU utilization while maintaining acceptable training result accuracy, etc.). Given a function F (called the objective function), we find the smallest and largest values of F subject to the training constraints, i.e., it's maxima and minima can be identified using a variety of heuristic and machine learning algorithms, such as function minimization, clustering, ANN, and the like. In extremizing, a value of the tuning parameter is chosen such that F achieves it's extremal value (high or low, depending on the goal). This can be done with an exhaustive search (slow and accurate), or heuristically (fast and approximate), or iteratively (fast and approximate).

In step 360, the selected tuning parameter C is adjusted to “tune” the system 100. Tuning the system 100 may require adjusting more than one tuning parameter C. In fact, multiple tuning parameters can be adjusted at one time. The tuning server 150 inputs M and selects a new configuration, outputting C subject to F to achieve a specific performance objective, such as balancing the ratio of communication/computation. In some embodiments, this is accomplished by the tuning server 150 sending an instruction to the training program execution unit 120 to modify its high-dimensional search algorithms to incorporate the adjusted tuning parameter C. For example, when (dynamic) thresholds are triggered, the tuning server 150 instructs the training program execution unit 120 to modify its training algorithms to include (exclude) compression and decompression algorithms applied to the model update parameters (e.g. dropout sparsification to send a quasi-random subset of weights; or rolling updates that transmit only a pre-specified subset of weights in a round-robin fashion; or variable bit truncations of the weights to be combined; or a combination of these methods, etc.).

In some embodiments, the tuning server 150 accelerates/decelerates the computation. For example, the training program execution unit 120 can be instructed to change the size of the mini-batch to 16. Additionally, approximate computing techniques can be used to avoid unnecessary/probabilistic serialization, and/or computation could switch from single to double precision to half precision, or a combination of both. The new configuration R′ can be selected by making adjustments to: 1) accelerate/decelerate communication; 2) accelerate/decelerate computation; or 3) both.

Referring again to FIG. 3, the process returns to step 320 to continue system monitoring. If, however, in decision step 340, the system is found to be in balance, then the current, balanced configuration space is stored in step 370. This balanced configuration can be used as a benchmark.

In some embodiments, the tuning server 150 notes the time it takes for communication vs. computation and tries to balance them. For example, the communication time shouldn't make the computation take longer. One way to get computation/communication to match as efficiently as possible is to use pipelining. Achieving balance in the ratio of computation to communication, however, cannot be done at the expense of the training error rate.

Some tuning methods can affect the training output and thus the error rate. For example, using lower/higher resolution can affect the image quality. As an example, assume a communication bottleneck is observed. This could be caused by sending data that is unnecessarily precise. Using the principles of approximate computing, adjusting the tuning parameters to shorten the number of digits will speed up communication, but some accuracy may be lost. This loss in accuracy may be acceptable in the short run, but may cause problems later in the process. That's why it is important to continue monitoring the training accuracy to make sure the adjustments are not degrading the results to an unacceptable rate. The operator will determine an acceptable error rate. For many machine learning training processes, the error rate can start out at 100%, then the system learns and the error rate goes down to an acceptable five or ten percent. The tuning server 150 has to work within the acceptable error rate provided by the operator.

Some approximate computing techniques affecting computation time include switching from single to double precision to half precision, for example. By doing so the system 100 dynamically updates the training parameters of the training process to modulate the compute time relative to the communication time, and thereby moves toward parsimonious utilization of system resources for accelerated training. The compression in this case could be any of the many techniques known to those skilled in the art, such as random sparsification or thresholded drop-out, and the like.

FIG. 4 depicts a block diagram of the components for performance profiling of a system with approximate computing, according to an embodiment of the present invention. In some embodiments, application performance profiling contributes to the approximate computing tuning method 255 (of FIG. 2). An application 110 (FIG. 1) can be profiled in order to understand the application's behavior and system usage.

Referring now to FIG. 4, performance data probes 455 are judiciously inserted into an application, depending on the performance objective. In some embodiments, the performance data probes 455 are embodied as “hooks” or “patches” 402 to the program source 408, and/or sensors in the hardware. For example, probes 455 can be applied to the program source code 405 for reporting source code instrumentation 409. A library patch 403 can be applied to the compiler 410 for profiling library linking 412 while a binary patch 415 and a runtime patch 416 can be applied to the program execution 120 for reporting binary/runtime instrumentation 424.

During system monitoring, readings from the performance data probes 455 are provided to and received e.g., by tuning server 150. These readings can reflect performance statistics such as bandwidth utilization, memory usage, and power/wattage consumed. Using known performance monitoring tools, data collection can also include performance data 450 cataloging system software events 435 and hardware counter events 445. For example, hardware counters are hardware-dependent counters that track a processor's performance, collecting data on hardware performance events such as cache hits, cache misses, instruction cycles, branch mis-predictions, and others. The performance statistics are stored in Performance Monitoring Units (PMUs). These are special purpose registers built into a processor to profile its hardware activity.

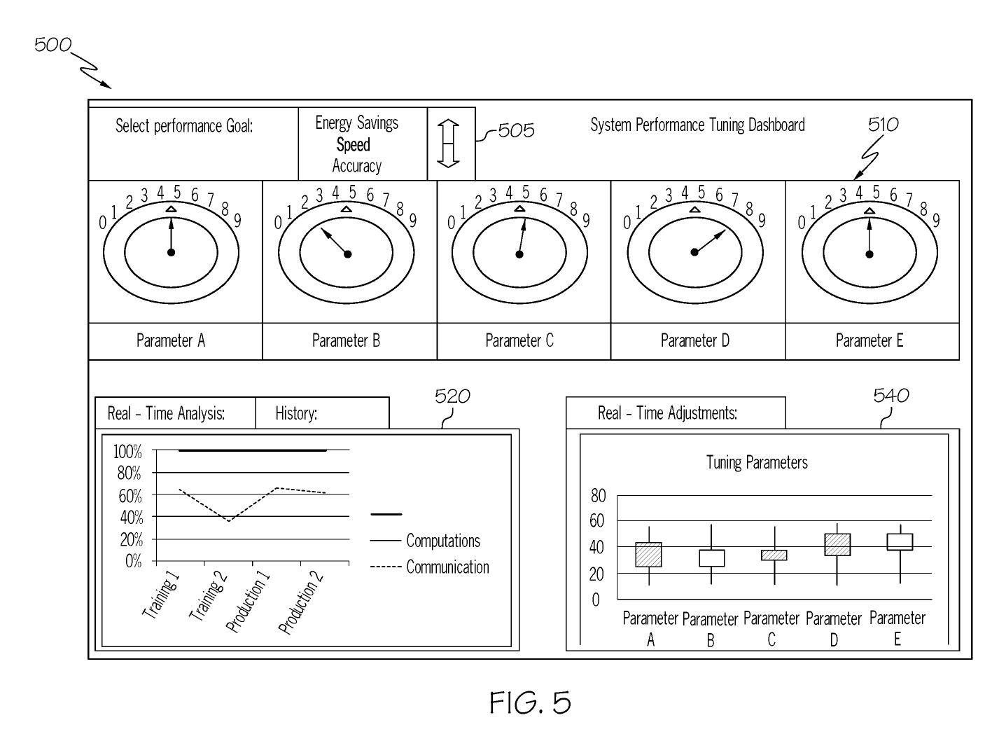

FIG. 5 shows an exemplary user interface featuring a dashboard 500, according to an embodiment of the present invention. The dashboard 500 depicts graphical representations of adjustable performance parameters conceptually depicted as tuning knobs 510. The tuning knobs 510 represent the performance parameters, or tuning parameters, that are adjusted during execution of the approximate computing tuning method 255.

In the non-limiting example of FIG. 5, the tuning knobs 510 are GUIs representing the tunable performance parameters. “Turning” the knobs 510 adjusts the values of the tuning parameters up or down, thus tuning the system to achieve the selected performance objective. Depending on the embodiment, only one tuning knob 510 can be adjusted at one time, or multiple tuning knobs 510 can be adjusted at the same time. The parameter values represented by the settings for the tuning knobs 510 can be adjusted after each iteration of a training run, or at specified times during a production run. There are certain time intervals or certain time points when the adjustments can be made without slowing down the training/production run.

Tuning knobs 510 controlled by the tuning server 150 can reflect hardware/software settings. The tuning parameters represented by the tuning knobs 510 can be specified by type and range. They can be continuous, discrete, or nominal. Their range can be specified as min, max, default, delta (minimum value when adjusting). Some examples of the tuning parameters represented by the tuning knobs 510 are: number of threads, size of buffer, approximate computation (floating points precision for certain computation), and update frequency.

One possible action is to adjust the precision in the hardware. In addition, the tuning can include changing how frequently the process updates. The objective of adjusting the tuning knobs 510 is to reach a specific performance objective without degrading the correctness/execution results. Some non-limiting examples of tuning by adjusting the tuning parameters can include: increasing/decreasing data compression, changing a mini-batch size, changing a number of hidden layers in a deep neural network, changing a number of nodes for parallelization, changing a learning step size, changing the percentage of the machine learning model communicated at each update, changing the update algorithm, changing the method for calculating the derivative, changing the momentum parameter, changing the number of bits of data resolution communicated, and changing a size of the machine learning model.

The dashboard 500 can contain a GUI 505 that allows a user to select and view a specific performance objective. Each performance goal is related to measurable performance criteria. The performance objective can be changed in real-time, as desired by the operator. Performance objectives may need to be changed in response to workload changes, changes in input data, or for other reasons. The system monitoring and tuning is performed according to the current performance objective.

In some embodiments, once the approximate computing tuning method 255 identifies that performance is straying from the pre-selected performance objective during the monitoring phase, the tuning server 150 attempts to identify whether changing any of the performance parameter values will bring the system closer to the performance objective. If such values exist, the tuning server 150 will identify a performance parameter (tuning parameter) to be adjusted (either optimally or not) and instruct the training/production system to use the new parameter value. This automatic identification and selection of the tuning parameter can be reflected on the dashboard 500.

This adjustment can be done “experimentally” to see whether a change helps and then reverse the change (or make another change) if the system's performance becomes worse. Thus automatic experimentation (exploration of the parameter space R) is an optional part of the system's behavior. Different tuning knobs 510 are adjusted to optimize different tuning parameter values for both training and production functions. The operator is able to view the adjustments by noting the changes to the tuning knobs 510. In some embodiments, the operator is able to override the changes made by the tuning server 150 by manipulating the tuning knobs 510 on the dashboard 500.

The dashboard 500 example shown in FIG. 5 shows that the selected performance goal is “Speed” and shows just a few performance parameters: A, B, C, D, and E, for simplicity. The tuning knobs 510 corresponding to the performance parameters reflect the current settings. The dashboard 500 also includes a chart 520 providing a performance report. The operator can select either a real-time report of the current performance run, or a performance history report. Providing the ability to “see” the current system performance is significant because at least some of the tuning parameters can be adjusted in real-time, while an application is running. It should be noted that the “performance” is relative to the particular goal that is selected by the user. In addition to the above, a chart 540 shows the current values and the changes in values for the tuning parameters.

The simplified example of a dashboard 500 shown in FIG. 5 contains just a few elements. One with knowledge in the art will appreciate that a system performance tuning dashboard 500 can include many more graphical user interface (GUI) modules and/or widgets in addition to those shown here.

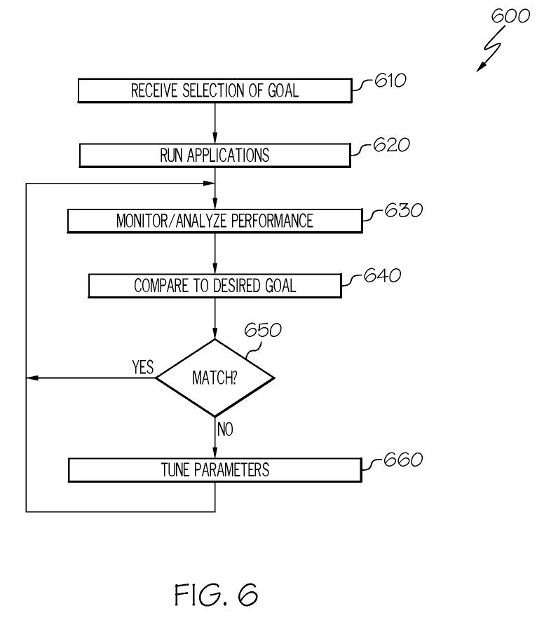

FIG. 6 shows a flow diagram 600 of an approximate computing tuning process, according to an embodiment of the present invention. In this example, the tuning process is performed by the tuning server 150 and can incorporate a graphical user interface such as the dashboard 500 shown in FIG. 5.

As depicted in FIG. 6, in step 610 the tuning server 150 receives the performance objective. As previously stated, the performance objective can be speed, accuracy, energy saving, or a host of other performance objectives. The performance objective can be set by the tuning server 150 based on observations of system performance. The performance objective can be set before a training/production run begins, or after observing the system's performance, and the performance objective can be changed at any time.

The training/production application is run in step 620. As the application is running, the system performance is analyzed in step 630. In particular, the performance criteria related to the specific performance objective are analyzed, and in step 640 the performance criteria are compared to the desired performance objective in step 640. If the performance criteria are in line with the selected performance objective, as determined in decision step 650, then the process loops back to step 630 to continuing monitoring the system's performance. If, however, step 650 determines that the performance criteria indicate that the performance objective is not being met, then in step 660, the tuning parameters are adjusted to tune the system. Once again the process loops back to step 630 to continue system monitoring.

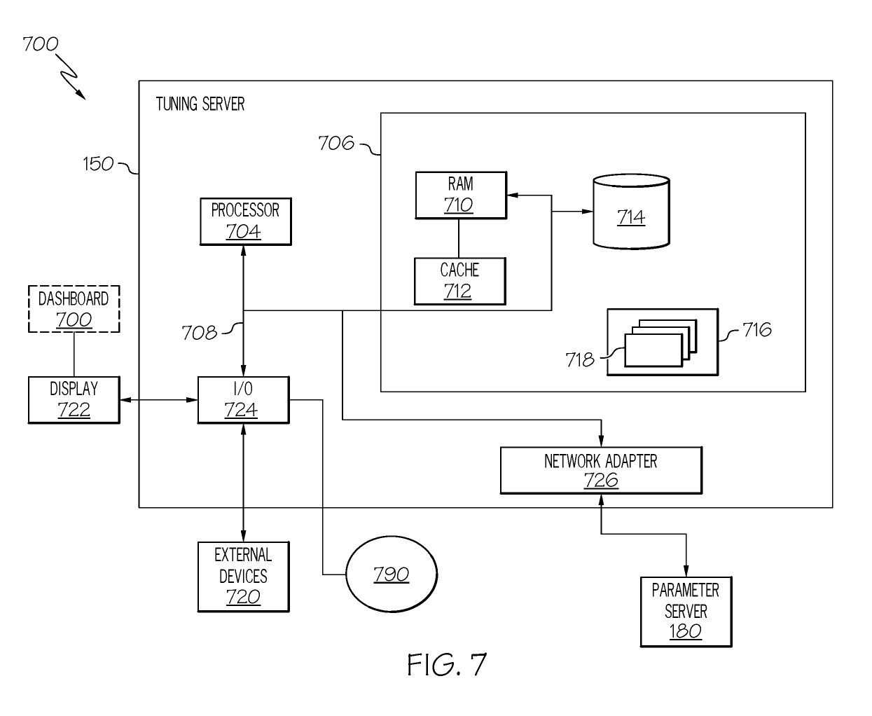

FIG. 7 illustrates a block diagram of an exemplary system for tuning machine learning systems, according to an embodiment of the present invention. The system 700 shown in FIG. 7 is only one example of a suitable system and is not intended to limit the scope of use or functionality of embodiments of the present invention described above. The system 700 is operational with numerous other general purpose or special purpose computing system environments or configurations. Examples of well-known computing systems, environments, and/or configurations that may be suitable for use with the information processing system 700 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, clusters, and distributed cloud computing environments that include any of the above systems or devices, and the like.

The system 700 may be described in the general context of computer-executable instructions, being executed by a computer system. The system 700 may be practiced in various computing environments such as conventional and distributed computing environments where tasks are performed by remote processing devices that are linked through a communications network. In a distributed computing environment, program modules may be located in both local and remote computer system storage media including memory storage devices.

Referring again to FIG. 7, system 700 includes the tuning server 150. In some embodiments, tuning server 150 can be embodied as a general-purpose computing device. The components of tuning server 150 can include, but are not limited to, one or more processor devices or processing units 704, a system memory 706, and a bus 708 that couples various system components including the system memory 706 to the processor 704.

The bus 708 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

The system memory 706 can also include computer system readable media in the form of volatile memory, such as random access memory (RAM) 710 and/or cache memory 712. The tuning server 150 can further include other removable/non-removable, volatile/non-volatile computer system storage media. By way of example only, a storage system 714 can be provided for reading from and writing to a non-removable or removable, non-volatile media such as one or more solid state disks and/or magnetic media (typically called a “hard drive”). A magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to the bus 708 by one or more data media interfaces. The memory 706 can include at least one program product embodying a set of program modules 718 that are configured to carry out one or more features and/or functions of the present invention e.g., described with reference to FIGS. 1-6. Referring again to FIG. 7, program/utility 716, having a set of program modules 718, may be stored in memory 706 by way of example, and not limitation, as well as an operating system, one or more application programs, other program modules, and program data. Generally, program modules may include routines, programs, objects, components, logic, data structures, and so on that perform particular tasks or implement particular abstract data types. Each of the operating system, one or more application programs, other program modules, and program data or some combination thereof, may include an implementation of a networking environment. In some embodiments, program modules 718 are configured to carry out one or more functions and/or methodologies of embodiments of the present invention.

The tuning server 150 can also communicate with one or more external devices 720 that enable interaction with the tuning server 150; and/or any devices (e.g., network card, modem, etc.) that enable communication with one or more other computing devices. A few (non-limiting) examples of such devices include: a keyboard, a pointing device, a display 722 presenting system performance tuning dashboard 500, etc.; one or more devices that enable a user to interact with the tuning server 150; and/or any devices (e.g., network card, modem, etc.) that enable the tuning server 150 to communicate with one or more other computing devices. Such communication can occur via I/O interfaces 724. In some embodiments, the tuning server 150 can communicate with one or more networks such as a local area network (LAN), a general wide area network (WAN), and/or a public network (e.g., the Internet) via network adapter 726, enabling the system 700 to access a parameter server 180. As depicted, the network adapter 726 communicates with the other components of the tuning server 150 via the bus 708. Other hardware and/or software components can also be used in conjunction with the tuning server 150. Examples include, but are not limited to: microcode, device drivers, redundant processing units, external disk drive arrays, RAID systems, tape drives, and data archival storage systems.

As will be appreciated by one skilled in the art, aspects of the present invention may be embodied as a system, method, or computer program product 790 at any possible technical detail level of integration. The computer program product 790 may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Accordingly, aspects of the present invention may take the form of an entirely hardware embodiment, an entirely software embodiment (including firmware, resident software, microcode, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, although not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, although not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention have been discussed above with reference to flowchart illustrations and/or block diagrams of methods, apparatus (systems) and computer program products according to various embodiments of the invention. It will be understood that each block of the flowchart illustrations and/or block diagrams, and combinations of blocks in the flowchart illustrations and/or block diagrams, can be implemented by computer program instructions.

These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer program instructions may also be stored in a non-transitory computer readable storage medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, although do not preclude the presence or addition of one or more other features, integers, steps, operations, elements, components, and/or groups thereof.

The description of the present application has been presented for purposes of illustration and description, but is not intended to be exhaustive or limited to the invention in the form disclosed. Many modifications and variations will be apparent to those of ordinary skill in the art without departing from the scope and spirit of the invention. The embodiments were chosen and described in order to best explain the principles of the invention and the practical application, and to enable others of ordinary skill in the art to understand various embodiments of the present invention, with various modifications as are suited to the particular use contemplated.

What is claimed is:

1. A computer-implemented method for tuning a machine learning model using approximate computing, the computer-implemented method comprising:
defining, by a computer within a machine learning system, an n-dimensional approximate computing configuration space, the n-dimensional approximate computing configuration space comprising at least one tuning parameter for tuning the machine learning system;
setting, by the computer, a performance objective for the machine learning system that identifies one or more machine learning system performance criteria;
collecting and monitoring performance data of the machine learning system performance;
comparing the performance data to the machine learning system performance objective; and
dynamically updating the n-dimensional approximate computing configuration space by adjusting the at least one tuning parameter, in response to the comparing.

2. The computer-implemented method of claim 1 wherein the collecting and monitoring are performed in a background process.

3. The computer-implemented method of claim 1 wherein the at least one tuning parameter is selected from a group consisting of: data compression, update step size, and weighting.

4. The computer-implemented method of claim 1 wherein adjusting the at least one tuning parameter is an adjustment selected from a group consisting of: increasing data compression, decreasing data compression, changing a mini-batch size, changing a number of hidden layers in a deep neural network, changing a number of nodes for parallelization, changing a learning step size, changing a percentage of the machine learning model communicated at each update, changing an update algorithm, changing a method for calculating a derivative, changing a momentum parameter, changing a number of bits of data resolution of communicated, and changing a size of the machine learning model.

5. The computer-implemented method of claim 1 wherein the performance criteria is selected from a group consisting of: convergence rate, gradient update momentum, time to compute a mini-batch, and time to communicate an update.

6. The computer-implemented method of claim 1 further comprising providing a graphical user interface with adjustable graphical elements representing real-time values of the tuning parameters.

7. The computer-implemented method of claim 6 wherein a dynamic update of the n-dimensional approximate computing configuration space is overridden by engagement of the adjustable graphical elements.

8. The computer-implemented method of claim 1 further comprising changing the machine learning system performance objective in response to system changes.

9. The computer-implemented method of claim 1 wherein updating the n-dimensional approximate computing configuration space further comprises determining what tuning parameters to adjust using at least one of: linear programming algorithms, iterative methods, and heuristic algorithms.

10. A computer system for tuning a machine learning model using approximate computing, the computer system comprising:
a processor device; and
a memory operably coupled to the processor device and storing computer-executable instructions causing:
defining, by a computer within a machine learning system, an n-dimensional approximate computing configuration space, the n-dimensional approximate computing configuration space comprising at least one tuning parameter for tuning the machine learning system;
setting, by the computer, a performance objective for the machine learning system that identifies one or more machine learning system performance criteria;
collecting and monitoring performance data of the machine learning system performance;
comparing the performance data to the machine learning system performance objective; and
dynamically updating the n-dimensional approximate computing configuration space by adjusting the at least one tuning parameter, in response to the comparing.

11. The computer system of claim 10 further comprising a graphical user interface with adjustable graphical elements representing real-time values of the tuning parameters.

12. The computer system of claim 10 wherein the machine learning model is a neural network.

13. The computer system of claim 10 wherein the computer-executable instructions for dynamically updating comprise at least one of: linear programming algorithms, iterative methods, and heuristic algorithms.

14. The computer system of claim 13 wherein dynamically updating the n-dimensional approximate computing configuration space further comprises sending an instruction to modify a training algorithm to incorporate an adjusted tuning parameter.

15. The computer system of claim 14 wherein the instruction to modify the training algorithm comprises an instruction to incorporate multiple adjusted tuning parameters at one time.

16. A computer program product for tuning a machine learning model using approximate computing, the computer program product comprising:
a non-transitory computer readable storage medium readable by a processing device and storing program instructions for execution by the processing device, said program instructions comprising:
defining, by a computer within a machine learning system, an n-dimensional approximate computing configuration space, the n-dimensional approximate computing configuration space comprising at least one tuning parameter for tuning the machine learning system;
setting, by the computer, a performance objective for the machine learning system that identifies one or more machine learning system performance criteria;
collecting and monitoring performance data of the machine learning system;
comparing the performance data to the performance objective; and
dynamically updating the n-dimensional approximate computing configuration space by adjusting the at least one tuning parameter, in response to the comparing.

17. The computer program product of claim 16 wherein the program instructions further comprise providing a graphical user interface with adjustable graphical elements representing real-time values of the tuning parameters.

18. The computer program product of claim 16 wherein the program instructions for updating the n-dimensional approximate computing configuration space further comprise determining what tuning parameters to adjust using at least one of: linear programming algorithms, iterative methods, and heuristic algorithms.

19. The computer program product of claim 18 wherein the program instructions for updating the n-dimensional approximate computing configuration space further comprise sending an instruction to modify a training algorithm to incorporate an adjusted tuning parameter.

20. The computer program product of claim 16 wherein the machine learning model is a neural network.
